(19) United States
(12) Patent Application Publication
(10) Pub. No.: US 2017/0305047 A1
(43) Pub. Date: Oct. 26, 2017

(54) PRODUCTION OF MULTISHELL COMPOSITE-MATERIAL COMPONENTS WITH REINFORCEMENT STRUCTURE BONDED THERETO

(71) Applicant: BASF SE, Ludwigshafen (DE)

(72) Inventors: Thomas BAYERL, Mainz (DE); Rene HOLSCHUH, Ludwigshafen (DE); Andreas NIXDORF, Mannheim (DE)

(73) Assignee: BASF SE, Ludwigshafen (DE)

(21) Appl. No.: 15/507,260

(22) PCT Filed: Aug. 27, 2015
(86) PCT No.: PCT/EP2015/069585

§ 371 Date: Feb. 28, 2017

(30) Foreign Application Priority Data
Sep. 4, 2014 (EP) 14183500.9

(51) Int. Cl. B29C 45/14; B29C 65/00; B29C 65/56; B62D 29/00

(52) U.S. Cl. CPC B29C 45/14786; B29C 66/543; B29C 65/56; B62D 29/00

(57) ABSTRACT

The invention relates to a process for the production of multishell composite-material components, comprising the following steps:
a) insertion of at least one first component (1) into an injection mold and optionally subjecting the first component (1) to a forming process,
b) injection of at least one fixing element (4) onto at least one side (5) of the first component (1),
c) insertion of at least one second component (2) into the injection mold and optionally subjecting the second component (2) to a forming process,
d) bonding of the first component (1) to the second component (2) by way of the side (5) which has the fixing element (4), where a matrix material (6) is injected through the second component (2) onto and/or into the fixing element (4).

The invention relates to a process for the production of multishell composite-material components, comprising the following steps:
a) insertion of at least one first component into an injection mold and optionally subjecting the first component to a forming process,
b) injection of at least one fixing element onto at least one side of the first component,
c) insertion of at least one second component into the injection mold and optionally subjecting the second component to a forming process,
d) bonding of the first component to the second component by way of the side which has the fixing element, where a matrix material is injected through the second component onto and/or into the fixing element.

The invention further relates to a multishell component made of composite material and produced by the process of the invention, and also to a molding composed of at least one first component and of a second component, where the first component has, on at least one side, a fixing element, and the second component has been bonded coherently to the fixing element.

The importance of fiber-composite plastics, in particular continuous-fiber-reinforced thermoplastics, is increasing greatly because they have high potential for lightweight construction and for recycling. Specifically in automobile construction, further progress is being made with the replacement of metals by thermoplastic laminates, because these have good mechanical properties together with capability for efficient processing in combination with the injection-molding process.

In recent years a constantly increasing number of metallic components have been replaced by fiber-plastics-composite components of lower weight. The automobile industry in particular requires, for this purpose, processes which permit efficient and inexpensive mass production. Whereas traditional metallic automobile components are generally of single-shell design with reinforcing ribs and beads, single-shell fiber-plastics composites (FPCs) cannot always be used within the same installation space. In order to make full use of the performance characteristics of FPCs, two-shell solutions are used. Sandwich processes provide an example of these two-shell solutions. These are established processes used for thermoset and also thermoplastic materials, assisted by structural foams. However, this approach is expensive and therefore has only limited use for mass production.

There are likewise two-shell solutions for thermoplastic processes, but these cannot be coupled with the very recently developed process combination of in-mold forming and overmolding (IFO), or are not capable of using the full potential of the material. In the IFO process a preheated thermoplastic organopanel is subjected to forming under pressure and is then overmolded with a thermoplastic injection-molding composition. A rib structure is often introduced here, and in the case of a two-shell design this must be sealed.

In a solution currently used, a second organopanel is placed on the ribs, and a compression process is used to bond the edges of the organopanels. However, no bonding is achieved here between injected ribs and the superposed organopanel, and there can be resultant loss of performance.

The current processes are generally very complicated, because either a gas is injected which applies the counterpressure to the laminate so that a smooth surface can be produced or a subsequent step is used for adhesive bonding or for jointing.

Another known process has hitherto functioned only by way of an additional hot-gas nozzle which reheats the laminate at the joins.

The document DE 2008 013 506 A1 describes a process for the production of a composite component made of at least one molding which is made of metal and/or plastic and which, in an injection mold, is subjected to a joining process and to an interlock-bonding or coherent bonding process with respect to itself and/or to another molding, where the at least one molding is subjected to a joining process on closure of the injection mold. For this, by way of example, an adhesive is used at the join regions.

DE 195 00 790 A1 discloses a process for the production of plastics/metal composite products with a combination of metal-joining and, respectively, pressing processes using at least two individual metal sheets and injection molding of a thermoplastic. In a first step here, individual metal sheets to be bonded are placed in the injection mold and bonded to one another coherently by a joining or pressing process. In a second step, thermoplastic is injected at perforations of the metal sheets to bond the sheets to one another and to the plastics part formed in the remainder of the cavity of the injection mold. A disadvantage of this known process is that although the pressing of the moldings and the injection of plastic took place in one device, they take place in two separate steps.

DE 10 2009 010 440 A1 describes a module composed of an external shell and of a structural component bonded to the external shell. The arrangement here has the structural component and the external shell at a distance from one another, at least in some regions, and at least in some regions there is a frictional bond between the structural component and the external shell, in order to fix the position of the structural component relative to the external shell.

DE 195 04 726 A1 describes a large-surface-area element which is torsionally rigid and has load bearing capability, made of two parts, having an insertion device and internal reinforcement systems. The two halves here are joined to one another by using an insertion device and appropriate bonding elements. By virtue of specific functional integration in the case of one of the two halves—for example production of bonded elements on the plastics subelement during manufacture—it becomes possible to bond different combinations of material to give a large-surface-area element that is torsionally rigid and has load bearing capability.

DE 10 2011 111 743 A1 describes an FPC component and a production process for same, where the component has at least one textile insert in a composite with a thermoplastic matrix, and comprises, injected onto the material, reinforcement ribs made of thermoplastic. The thermoplastic ribs of the FPC component comprise short fibers made of a reinforcement material with a proportion by volume of at least 30%.

DE 10 2013 011 316 A1 describes an underbody cladding with a shell that is an external shell. Bonded to the external shell there is an internal shell, and between the internal shell and the external shell there is at least an intervening space present.

DE 10 2009 041 838 A1 describes a process for the production of a bonded joint, produced by plastics technology, between at least two at least sectionally sheet-like elements or subregions of a plastics component.

DE 42 42 059 C1 describes a process for the thermal bonding of plastics moldings to other plastics components by means of an intermediate layer applied via plasma polymerization. The process is characterized in that the intermediate layer is applied via plasma polymerization and is formulated in such a way that it has, at least in comparison with the moldings, a low melting point, where the intermediate layer is similar to the moldings/foils/molded foams, but a different molecular chain length or crosslinking structure in the intermediate layer is established via suitable balancing of the plasma conditions.

DE 10 2011 118 980 A1 discloses a process for the production of an external module with external paneling for a modular-structure housing component. For this, the thermoplastic FPC internal shell is provided via cutting-to-size and molding of a semifinished thermoplastic continuous-fiber product in accordance with the shape of an internal shell, and in-mold coating with the stiffening elements. This is followed by cutting-to-size and preforming of a semifinished thermoplastic continuous-fiber product in accordance with a shape for the external shell, and then the insertion of the thermoplastic FPC internal shell and of the preformed semifinished thermoplastic continuous-fiber product corresponding to the shape of the external shell into a mold, and closing of the mold. The preformed semifinished thermoplastic continuous-fiber product is then subjected to pressure, and shaping takes place to give the FPC external shell and joining of the FPC internal shell and of the FPC external shell takes place to give an unfinished external module.

None of the processes disclosed in the prior art describes a process which is useful for mass production and which can produce multishell composite-material components with reinforcement structure coherently bonded thereto.

It is therefore an object of the present invention to provide a process for mass-production manufacture of closed-shell, multishell components, in particular FPC components with a reinforcement structure bonded to both sides. The intention here is particularly preferably that the FPC component be amendable to production under conditions that are economically sustainable.

Said object is achieved via a process for the production of multishell composite-material components, comprising the following steps:
a) insertion of at least one first component into an injection mold and optionally subjecting the first component to a forming process,
b) injection of at least one fixing element onto at least one side of the first component,
c) insertion of at least one second component into the injection mold and optionally subjecting the second component to a forming process,
d) bonding of the first component to the second component by way of the side which has the fixing element, where a matrix material is injected through the second component onto and/or into the fixing element.

The process of the invention can provide multishell, in particular double-shell, composite-material components which have no adhesive bond. Since no adhesives are used in the bonding of the first component and of the second component in the present invention, it is possible that the resultant multishell composite-material components can be recycled to better effect. Since the process for recycling composite-material components requires the separation of the reinforcement fiber arrangement and the thermoplastic matrix, the presence of adhesives is disadvantageous for a subsequent recycling process. The composite-material components produced by the process of the invention can therefore be subjected to subsequent recycling in a manner that is less expensive and more sustainable.

The expression a multishell, in particular double-shell, composite-material component in the present invention means a (final) component, in particular a composite component, which has a closed-cell cross section. Advantages of composite components of this type are that, in comparison with solid composite components, they have higher torsional and/or flexural stiffness, or equal stiffness for lower weight of the composite component.

After provision of at least one first component, the process of the invention, in step a), places at least one first component in an injection mold and optionally subjects the first component to a forming process. The construction of the injection molds required for this purpose is known to the person skilled in the art. The meaning of a possible forming process in step a) is that the at least one first component can by way of example be thermoformed. It is equally possible that the at least one first component already has the desired shape, so that no forming process is required in step a).

In the step b) that follows this, at least one fixing element is injected onto at least one side of the first component. Injection of at least one further fixing element on this side can equally take place, so that the first component has at least two fixing elements. The arrangement of the fixing elements on the first component can preferably be symmetrical. If, by way of example, circular fixing elements are involved (e.g. beads), the arrangement of these with respect to one another can by way of example be linear, but in addition to this linear arrangement there can be arrangements with parallel displacement. If, by way of example, the fixing element takes the form of a rib, the arrangement can have these ribs parallel to one another. However, it is also possible that the arrangement has the ribs in the form of a cross. This preferably permits achievement of higher flexural stiffness values in the composite-material component.

In the step b) that follows it is equally possible that fixing elements are injected onto two opposite sides of the first component.

The step c) that follows the step b) relates to the placing of at least one second component in the injection mold and optionally subjecting the second component to a forming process. The meaning of a possible forming process in step c) is that the at least one second component can by way of example be thermoformed. It is equally possible that the at least one second component already has the desired shape, so that no forming process is required in step c).

The step d) that follows the step c) relates to the bonding of the first component, by way of the side having the fixing element, to the second component, where a matrix material is injected through the second component onto and/or into the fixing element. Injection through the second component means that the material at this location is separated from an appropriate device and/or from an appropriate stream of material, in particular of the matrix material, and that the matrix material can be introduced onto and/or into the fixing element. By way of example, the matrix material can flow under elevated pressure in the form of a concentrated jet through the second component and be injected onto and/or into the fixing element. It is also possible to pass, through the second component, a metal broach, which is then followed by the matrix material. A hole is thus preformed which provides a passage for the matrix material to the cavity of the at least one fixing element. It is equally possible that the second component is heated only locally and thus becomes locally soft for the flow of the matrix material, or that the hole described above for the matrix material has already been preformed in the second component and that the component remains cold.

The bonding of the first component and of the second component in step d) of the present invention preferably gives a multishell structure. In particular, it is possible to achieve a three-part structure when the first component has at least two fixing elements on opposite sides of the first component. A three-shell structure is generated after bonding to the second component.

It is moreover possible to incorporate intermediate steps between the successive steps a), b), c) and d), and/or to carry out further steps before the step a) and/or after the step d).

The first and/or second component can also be described as semifinished product and/or semifinished sheet.

It is particularly preferable that the first and/or second component has been manufactured from an optionally fiber-reinforced polymer. The polymer here can be a thermoplastic or a thermoset. In particular, the component can be a reinforced polymer. Reinforcement can be achieved by using a substance different from the polymer material.

In the process of the invention it is preferable that the fixing element has at least one cavity. It is preferable that the fixing element has at least two cavities. The nature of the cavities is preferably such that not only the coherent bond but also an interlocked bond or frictional bond is formed during the bonding in step d).

It is particularly preferable that the fixing element serves as stiffening element.

The fixing element can preferably be formed as a hollow-body structure in the step b) of the process of the invention. The hollow-body structure here can by way of example have the shape of a hollow cube, block, cylinder, or truncated cone. A fill material can be injected into this hollow-body structure, and at most 99% of the internal volume here is filled by the fill material. It is preferable that a cavity results from this incomplete filling.

It is preferable that the fixing element and/or the fill material is composed of a thermoplastic polymer material. Any of the thermoplastics known to the person skilled in the art is suitable for this purpose. Examples of thermoplastics usually used are polyolefins, polyamides, polyurethanes, polyesters, polyethers, polyacrylates, polyacetals, and also polymers of monomers comprising vinyl groups.

Examples of polyolefins generally used are polyethylene, polypropylene, poly-1-butene, polytetrafluoroethylene. Suitable polyamides are by way of example nylon-6, nylon-11, nylon-6/6, nylon-6/10, and nylon-6/12. Suitable polyesters are by way of example polyethylene terephthalate, polybutylene terephthalate, and polycarbonate. Examples of polyacrylates usually used are poly(meth)acrylic esters, polymethacrylates, and polyacrylonitrile. An example of a polyacetal used is polyoxymethylene. Examples of suitable polymers which comprise monomer units having vinyl groups are polyvinyl chloride, polyvinylidene chloride, polystyrene, polyvinylcarbazole, polyvinyl acetate, and polyvinyl alcohol. Other suitable thermoplastics are polyether sulfone, polyetherimide, acrylonitrile-butadiene-styrene, styrene-acrylonitrile, and acrylate-styrene-acrylonitrile. It is moreover also possible to use mixtures of the abovementioned polymers, or copolymers made of the monomer units used to form the abovementioned homopolymers.

Particularly preferred thermoplastics for the fixing element are polyamides.

It is preferable that in step b) of the process of the invention a matrix material as used in step b) is used for the injection of the fixing element.

In an equally possible method of producing the cavity in the fixing element, a mask with an appropriate shape is used, in particular during the step b), and can be removed after the step b).

It is preferable in the process of the invention that the aspect ratio of the cavity is in the range from 1:1 to 1:100. In particular, the aspect ratio of the cavity is in the range from 1:2 to 1:50.

The aspect ratio is the ratio of the width to the height of the fixing element.

It is preferable that during the bonding of the first component and of the second component in the process of the invention a matrix material is injected into the cavity of the fixing element. The volume of matrix material injected is preferably from 50 to 300% of the cavity volume. The volume of matrix material injected is very particularly preferably from 80 to 250% of the cavity volume. The volume of matrix material injected is in particular from 105 to 125% of the cavity volume.

If the volume of matrix material injected is more than 100% of the cavity volume, the matrix material overflows out from the cavity. This overflow of matrix material can preferably serve as a basis for the interlock bonding and coherent bonding of the first and of the second component.

The overflow matrix material can very particularly preferably be used in the step d) for the bonding of the edge areas of the first component and of the second component.

It is preferable in the process of the invention that the first component and/or the second component comprises a reinforcing-fiber arrangement and a thermoplastic matrix. It is particularly preferable that the first and/or second component comprises a reinforcing-fiber arrangement in a thermoplastic matrix.

It is preferable that the first and the second component comprise different reinforcing-fiber arrangements. It is preferable that the first and second component comprise the same thermoplastic matrix.

Carbon fibers, glass fibers, aramid fibers, metal fibers, or combinations thereof can be used as reinforcing-fiber arrangement. The fiber arrangements used often have oriented fibers and comprise laid scrims, woven fabrics, nets, knitted fabrics, braided fabrics, and/or combinations thereof. In particular, the first and/or second component involve(s) fiber-composite plastics. These composite components made of fiber-reinforced plastics (fiber-composite plastic) have extremely good mechanical strength while at the same time providing great potential for weight saving. In particular, they are increasingly used in lightweight construction. The first and/or second component can therefore be formed by using a reinforcing fiber which by way of example can have been saturated or impregnated with a plastics material (plastics matrix), or can have been surrounded by a plastics material (plastics matrix).

The production of fiber-composite plastics or fiber-composite-plastic components is disclosed by way of example in DE 10 2008 052 000 A1. In that document, an injection mold is used with a matrix material for in-mold coating of, as reinforcement component, at least one unconsolidated textile insert formed from multifilament fibers fully or partially impregnated to core depth with an impregnating material.

The fibers used here can preferably take the form of individual fibers, rovings, or fiber mats. When the fibers used take the form of long fibers, rovings, or fiber mat, the fibers are usually placed in a mold, and impregnation by the polymer material then takes place. The resultant insert can have a structure of one or more layers. In the case of a multilayer structure, the fibers of the respective individual layers can have the same orientation, or the arrangement can have the fibers of the individual layers at an angle of from −90° to +90° to one another.

Another possible alternative, however, alongside the placing of the fibers in a mold and the casting of the polymer composition around these is, in particular when oriented long fibers are used, to pass these through an extrusion die and to sheath them with the plastics composition during the extrusion process.

When short fibers are used, these are usually admixed with the polymer composition before the hardening process. The insert can by way of example be manufactured via extrusion, injection molding, or casting. The insert generally comprises the short glass fibers in unoriented form. When the insert is produced by an injection-molding process, the forcing of the polymer composition comprising the fibers through an injection nozzle into the mold can orient the short fibers. In the case of extrusion of the polymer composition, orientation of the short fibers can likewise result from forcing of the material through the extrusion die.

Other suitable reinforcing agents, alongside fibers, are any desired other fillers which are known to the person skilled in the art and which act to increase stiffness and/or to increase strength. Among these are inter alia any desired particles having no preferential orientation. Particles of this type are generally spherical, lamellar, or cylindrical. The actual shape of the particles here can differ from the idealized shape: in particular, spherical particles can in practice by way of example also have a droplet-like or flattened shape.

Examples of reinforcing materials used alongside fibers are graphite, chalk, talc power, and nanoscale fillers.

Any of the thermoplastics known to the person skilled in the art is suitable for the thermoplastic matrix. Thermoplastics that can be reinforced are in particular suitable. Examples of thermoplastics usually used are polyolefins, polyamides, polyurethanes, polyesters, polyethers, polyacrylates, polyacetals, and also polymers of monomers comprising vinyl groups.

Examples of polyolefins generally used are polyethylene, polypropylene, poly-1-butene, polytetrafluoroethylene. Suitable polyamides are by way of example nylon-6, nylon-11, nylon-6/6, nylon-6/10, and nylon-6/12. Suitable polyesters are by way of example polyethylene terephthalate, polybutylene terephthalate, and polycarbonate. Examples of polyacrylates usually used are poly(meth)acrylic esters, polymethacrylates, and polyacrylonitrile. An example of a polyacetal used is polyoxymethylene. Examples of suitable polymers which comprise monomer units having vinyl groups are polyvinyl chloride, polyvinylidene chloride, polystyrene, polyvinylcarbazole, polyvinyl acetate, and polyvinyl alcohol. Other suitable thermoplastics are polyether sulfone, polyetherimide, acrylonitrile-butadiene-styrene, styrene-acrylonitrile, and acrylate-styrene-acrylonitrile. It is moreover also possible to use mixtures of the abovementioned polymers, or copolymers made of the monomer units used to form the abovementioned homopolymers.

Particularly preferred thermoplastics for the thermoplastic matrix are polyamides.

The polymers used can also comprise other additional substances. These are by way of example conventional plasticizers, impact modifiers, flame retardants, and other additives known to the person skilled in the art that are usually added to polymers.

In the process of the invention it is particularly preferable that the material of the matrix is the material of the thermoplastic matrix. In particular, the material of the matrix is the material of the thermoplastic matrix of the first and second component. It is thus possible to achieve particularly successful formation of coherent, interlock, and/or frictional bonds.

In the process of the invention it is preferable during the bonding of the first component and of the second component that material is injected into the cavity of the fixing element, where the surface of the cavity melts at least to some extent. In an example of a method for achieving this, the matrix material has been heated to a temperature which is higher than and/or equal to the melting point of the material of the fixing element.

In the process of the invention it is preferable that the forming process to which the first component and/or the second component is/are subjected in each case produces a single-shell fiber-plastics composite. The forming process can use an appropriate mold, for example an injection mold, for the preheated component.

In the process of the invention it is preferable that the fixing element is selected from the group consisting of ribs, convex areas, beads, grooves, fillets, and combinations thereof.

In the process of the invention it is particularly preferable that the first component and/or the second component is a long-fiber-reinforced thermoplastic, a continuous-fiber-reinforced thermoplastic, and/or a unidirectional, reinforced tape. The average fiber length of the long fibers here is in the range from 2 μm to 25 μm. The continuous fiber usually extends over the entire length of the component, and/or the length can be freely selected.

In the process of the invention it is preferable that the first component and/or the second component is an organopanel. The term organopanels means continuous-fiber-reinforced semifinished thermoplastic sheets. Organopanels can be subjected to a forming process on exposure to heat, and permit short process cycles, and moreover can be welded successfully. When organopanels are used, in contrast to metal sheets, the protection from corrosion is not always required.

Organopanels here can be composed of specific fiber arrangements which have fibers in defined orientations, embedded in the thermoplastic matrix: the fiber arrangements, in particular the reinforcing-fiber arrangements, can involve woven fabrics, laid scrims, knitted fabrics, or a combination thereof.

In the process of the invention it is preferable that, before bonding to the first component, the second component is brought to a temperature which is from up to 50° C. below to up to 50° C. above the melting point or the glass transition temperature. The melting point or the glass transition temperature preferably relates to the material of the thermoplastic matrix. It is particularly preferable that, before bonding to the first component, the second component is preheated locally, in order to minimize the energy consumed by the process.

Preference is given to a process of the invention in which, after and/or during bonding of the first component and of the second component, the edge areas of the second component are pressed onto the first component.

The present invention also provides a multishell composite-material component produced by the process of the invention. It is preferable to produce a two-part composite-material component.

The invention also provides a molding composed of at least one first component and one second component, where the first component has a fixing element on at least one side, and the second component has been bonded coherently to the fixing element.

All of the embodiments and preferred embodiments listed above can be combined freely with one another, unless it is clear from the context that this is not possible.

The expression “comprising” preferably also subsumes the expression “composed of”.

The invention and the prior art will be illustrated below with reference to the figures:

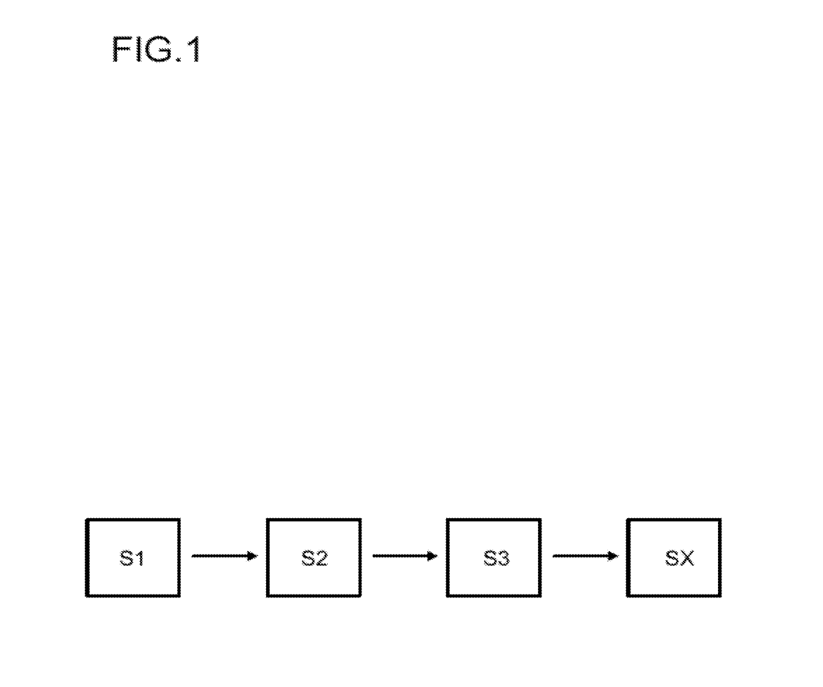

FIG. 1 is a diagram of the sequence for a combination of in-mold forming and overmolding (CIFO) processes (prior art).

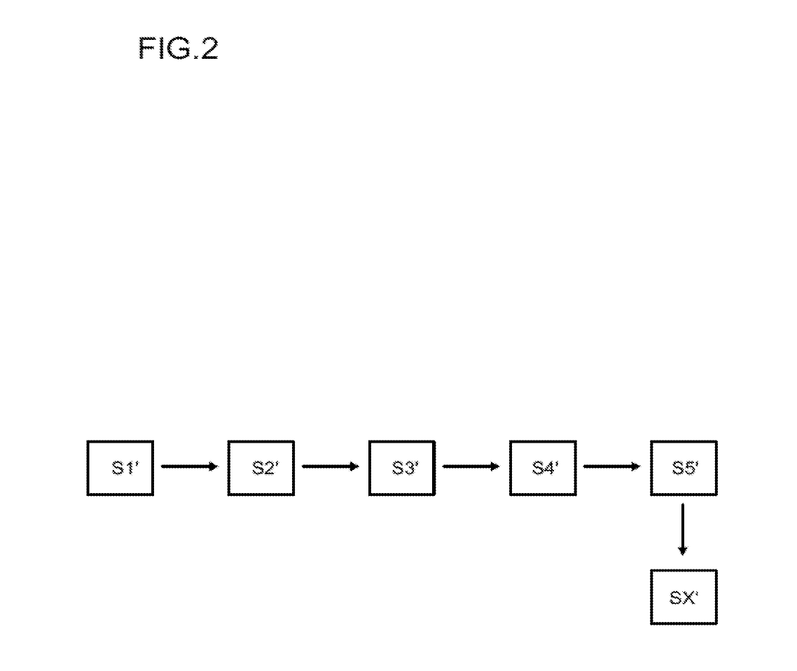

FIG. 2 is a diagram of the sequence of the process of the invention.

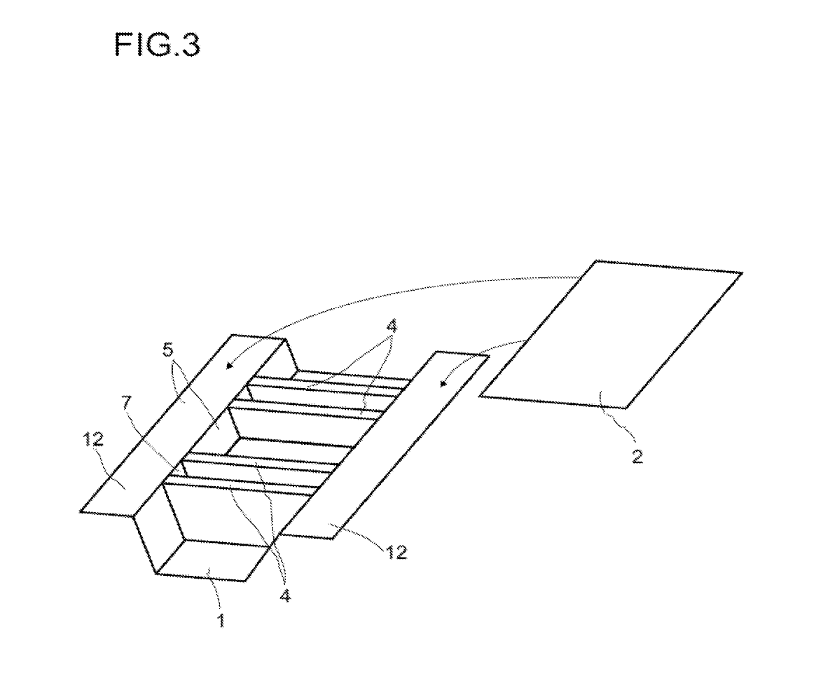

FIG. 3 shows the first and second component.

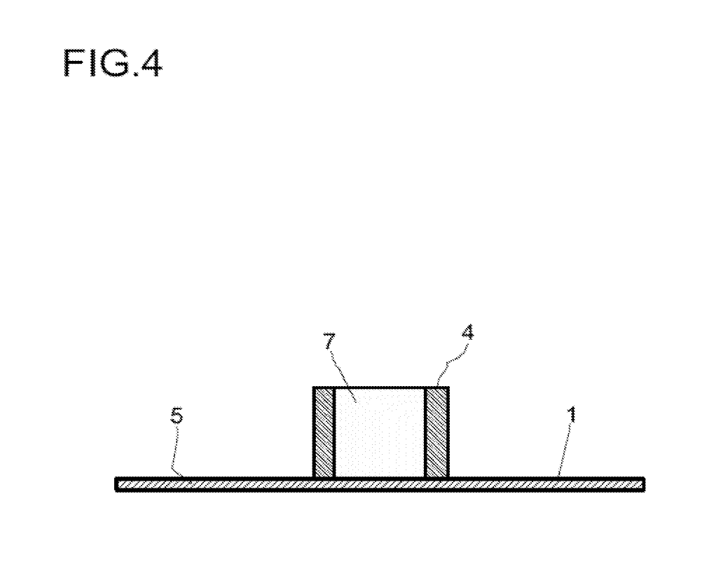

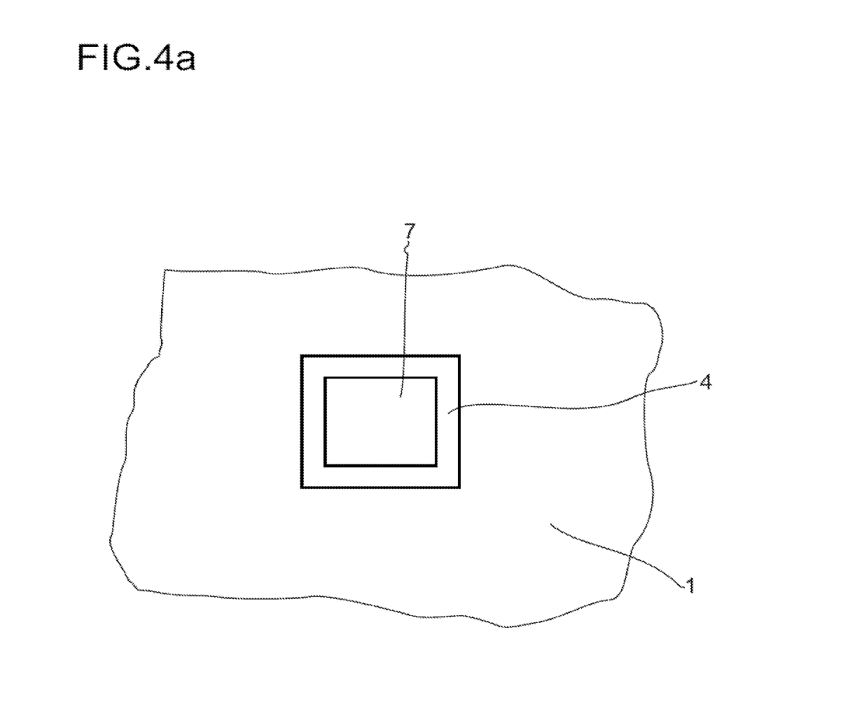

FIG. 4 is a section of a fixing element with a cavity.

FIG. 4a is a plan view of a fixing element with a cavity.

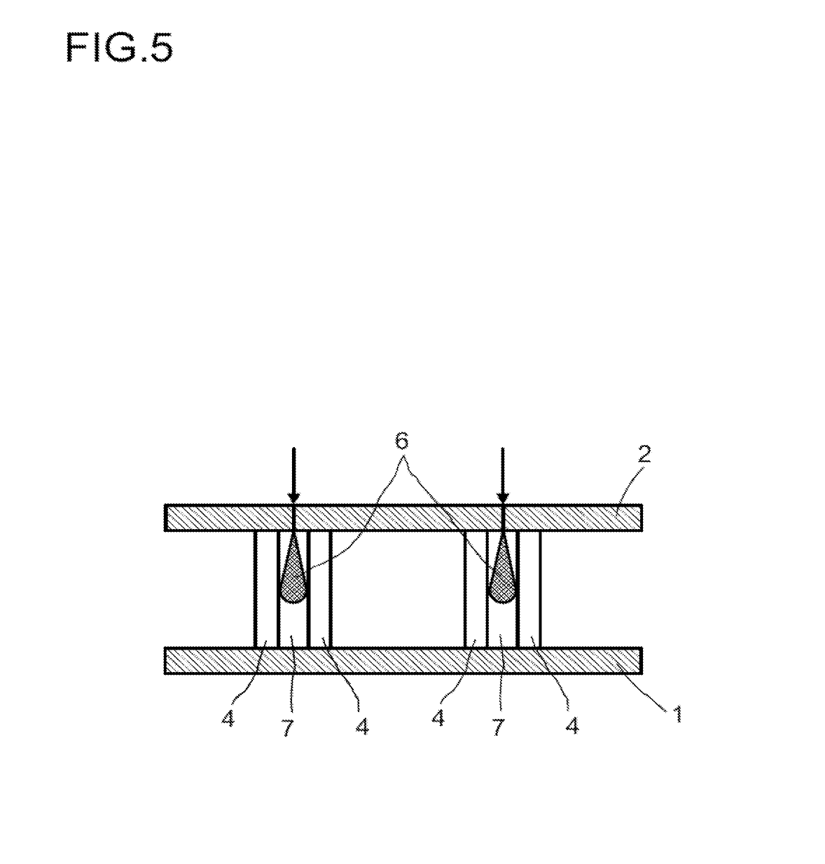

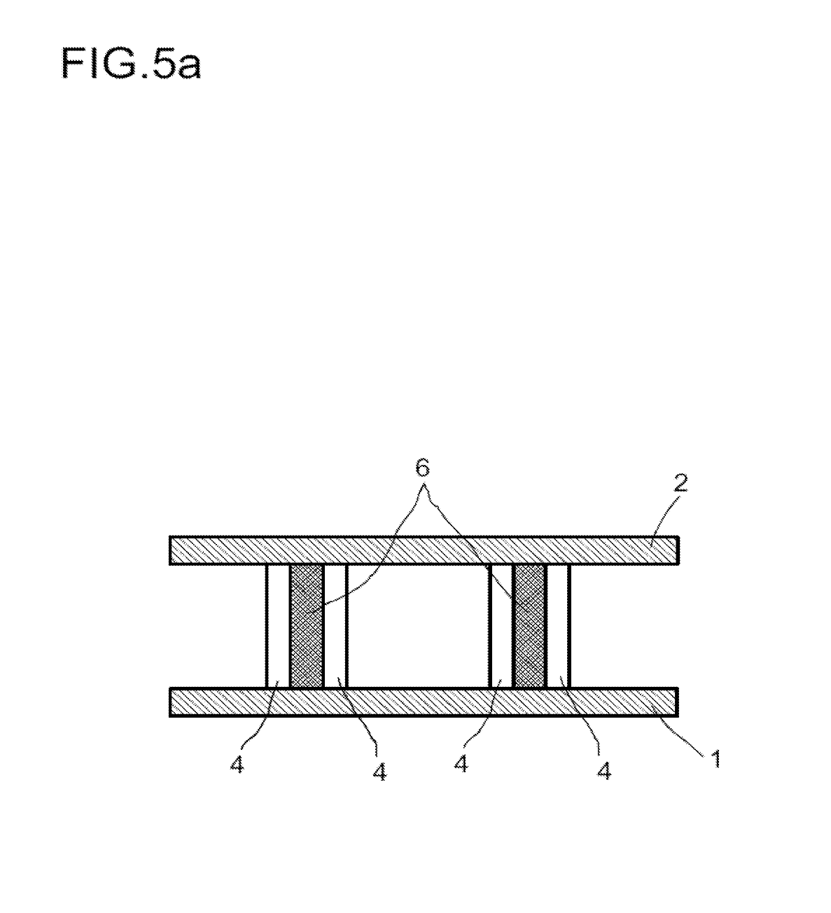

FIG. 5 shows a stage during the production of a double-shell composite-material component composed of a first and a second component during the procedure for injection of the matrix material.

FIG. 5a shows a stage during the production of a double-shell composite-material component composed of a first and a second component after the procedure for injection of the matrix material.

FIG. 1 is a diagram of the sequence of a CIFO process. For this, in step S1 a prefabricated semifinished product which can be either a laminate or a tape is optionally clamped into a clamping frame. Transport to an oven then takes place, so that the clamping frame with the semifinished product can be heated. This oven can by way of example be a radiant IR system. This is followed by insertion of material into the mold of the injection-molding machine. In the in-mold-forming process step S2 the mold is closed and the semifinished product is subjected to a forming process. After the forming process, in the overmolding step S3 the ribs, using an injection-molding composition, are injected. In further steps SX, the mold is then opened, and an optional demolding step and an optional trimming step then take place in order to obtain the final component.

FIG. 2 is a diagram of the sequence of the process of the invention. For this, in step S1′ a prefabricated semifinished sheet product made of a thermoplastic matrix and of a reinforcing-fiber arrangement is optionally clamped onto a clamping device. It is then possible either to heat the semifinished sheet product in the mold or to insert material into the mold. In the step S2′ the mold is closed and the semifinished product is subjected to a forming process. The steps S1′ and S2′ thus correspond to the first step a) in the process of the invention. Then in step S3′ fixing elements are appropriately injected. The fixing elements are injected only on one side, or on two opposite sides, of the semifinished product. The step S3′ thus corresponds to the step b) in the process of the invention. The fixing elements are accordingly injected in the form of injection-molding composition which is the same as the thermoplastic matrix. Then in step S4′ the mold is opened and again either material is inserted into the mold or the second semifinished sheet product is heated, this being followed by either the heating of the second semifinished sheet product or insertion of material into the mold. The step S4′ corresponds to step c) in the process of the invention. After the mold has been closed, the second semifinished product is optionally subjected to a forming process in step S4′. Then in step S5′ an injection-molding composition is injected through the second semifinished product into the cavity of the fixing elements. This results in coherent bonding of the two semifinished products. After the opening of the mold in step SX′ and any demolding, the product is a multishell component or the final component.

FIG. 3 shows a first component 1 and a second component 2. In the first component 1 the edge areas 12 and the fixing elements 4 and the cavity 7 can be seen. The second component 2 is accordingly applied to the first component 1. FIG. 3 illustrates a particular section of the process of the invention, but does not show the injection mold. After the first component 1 has been placed in the injection mold and subjected to a forming process, it has the shape illustrated in FIG. 3 with the edge areas 12. The fixing elements 4 injected in step b) of the process of the invention are likewise illustrated. In FIG. 3 there are in total four fixing elements 4, and the arrangement here of each pair of these is such that they have, between them, a cavity 7 into which the matrix material is subsequently injected. The arrangement of the fixing elements 4 here is such that they are flush in a plane with the upper side of the edge areas 12 of the first component 1. The second component 2, shown here in the form of flat component 2, can thus come into contact not only with the edge areas 12 of the first component 1 but also with an area of the fixing elements 4. FIG. 3 illustrates the situation before bonding of the first component 1 to the second component 2 by way of the side 5 which has the fixing element 4. Both the first component 1 and the second component 2 are composed of a reinforcing-fiber arrangement and of a thermoplastic matrix. The fixing element 4 is likewise composed of a thermoplastic matrix.

FIG. 4 is a section of a fixing element 4 with a cavity 7 on a first component 1. FIG. 4 shows the situation of the first component 1 after the injection of at least one fixing element 4 on at least one side 5 of the first component 1 as in step b). There is therefore not yet any matrix material in the cavity 7. The fixing elements 4 that form the cavity 7 have the shape of a rectangle.

FIG. 4a is a plan view of a first component 1 which has a fixing element 4. In plan view, the shape of the fixing element 4 is a square. The overall effect therefore is that a hollow cube-shaped molding provides the fixing element 4, but that side of the cube that faces away from the side 5 of the first component 1 is absent, and a cavity 7 is therefore present. The first component 1 is composed of a thermoplastic matrix in which there is a reinforcing-fiber arrangement. The fixing element 4 is equally composed of a thermoplastic matrix.

FIG. 5 shows a stage in the production of a double-shell composite-material component composed of a first component 1 and of a second component 2, during the injection procedure. The coherent bonding procedure can be seen in FIG. 5. The injection of the matrix material 6 through the second component 2 into the cavity 7 of the fixing element 4 is depicted here. For this, the component 2 is heated locally at the points through which the matrix material 6 is injected through the second component 2 as in step d) of the process of the invention. It is also possible to pass a metal broach through the second component 2 in order to permit passage for injection of the matrix material 6.

FIG. 5a shows a stage during the production of a double-shell composite-material component composed of a first component 1 and of a second component 2, after the step d) of the present process of the invention has been carried out. The coherent bond between the component 1 and the component 2 can be seen in FIG. 5a. FIG. 5a therefore corresponds to the stage after the step d) of the process of the invention. The matrix material 6 is the same as the material of the thermoplastic matrix of the first component 1 and of the second component 2, and also the same as the material of the fixing element 4. After the step d) a coherent, interlocking, and frictional bond has therefore been produced.

### KEY

1 First component
2 Second component
4 Fixing element
5 Side of first component
6 Matrix material
7 Cavity
12 Edge areas

1-15. (canceled)

16: A process for the production of multishell composite-material components, comprising:
a) insertion of at least one first component into an injection mold and optionally subjecting the first component to a forming process,
b) injection of at least one fixing element onto at least one side of the first component,
c) insertion of at least one second component into the injection mold and optionally subjecting the second component to a forming process,
d) bonding of the first component to the second component by way of the side which has the fixing element, wherein a matrix material is injected through the second component onto and/or into the fixing element.

17: The process according to claim 16, wherein the fixing element has at least one cavity.

18: The process according to claim 17, wherein the aspect ratio of the cavity is in the range from 1:1 to 1:100.

19: The process according to claim 17, wherein during the bonding of the first component and second component a matrix material is injected into the cavity of the fixing element.

20: The process according to claim 16, wherein the first component and/or the second component comprises a reinforcing-fiber arrangement and a thermoplastic matrix.

21: The process according to claim 20, wherein the material of the matrix is the same as the material of the thermoplastic matrix.

22: The process according to claim 17, wherein, during bonding of the first component and second component, material is injected into the cavity of the fixing element, and the surface of the cavity melts at least to some extent.

23: The process according to claim 16, wherein the forming process to which the first component and/or second component is/are subjected in each case produces a single-shell fiber-plastics composite.

24: The process according to claim 16, wherein the fixing element is selected from the group consisting of ribs, convex areas, beads, grooves, fillets, and combinations thereof.

25: The process according to claim 16, wherein the first component and/or the second component is a long-fiber-reinforced thermoplastic, a continuous-fiber-reinforced thermoplastic, and/or a unidirectional, reinforced tape.

26: The process according to claim 16, wherein the first component and/or the second component is an organopanel.

27: The process according to claim 16, wherein, before bonding to the first component, the second component is brought to a temperature which is from up to 50° C. below to up to 50° C. above the melting point or the glass transition temperature.

28: The process according to claim 16, wherein, after and/or during bonding of the first component and second component, the edge areas of the second component are pressed onto the first component.

29: A multishell composite-material component produced by the process according to claim 16.

30: A molding, comprising:
at least one first component and one second component, wherein the first component has a fixing element on at least one side, and the second component has been bonded coherently to the fixing element.
